(19) United States
(12) Patent Application Publication
(10) Pub. No.: US 2018/0150543 A1
(43) Pub. Date: May 31, 2018

(54) UNIFIED MULTIVERSIONED PROCESSING OF DERIVED DATA

(71) Applicant: LinkedIn Corporation, Sunnyvale, CA (US)

(72) Inventors: Dan Shacham, Sunnyvale, CA (US); Bryan S. Hsueh, Fremont, CA (US); Sertan Alkan, San Mateo, CA (US); Amit Yadav, Milpitas, CA (US); Ashish Gupta, San Jose, CA (US); Bee-Chung Chen, San Jose, CA (US)

(73) Assignee: LinkedIn Corporation, Sunnyvale, CA (US)

(21) Appl. No.: 15/364,627

(22) Filed: Nov. 30, 2016

(51) Int. Cl. G06F 17/30; G06F 7/20

(52) U.S. Cl. CPC G06F 17/30584; G06F 17/30377; G06F 17/30339; G06F 7/20

(57) ABSTRACT

The disclosed embodiments provide a system for processing data. During operation, the system obtains a set of derived data sets for use by a set of clients. For each derived data set in the set of derived data sets, the system produces a default version of the derived data set from multiple versions of the derived data set. The system then outputs the default version and the multiple versions for retrieval by the set of clients through an online data store, an offline data store, and a nearline data store.

### BACKGROUND

### Field

The disclosed embodiments relate to data processing. More specifically, the disclosed embodiments relate to techniques for performing unified multiversioned processing of derived data.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, data analytics may be used to assess past performance, guide business or technology planning, and/or identify actions that may improve future performance.

However, significant increases in the size of data sets have resulted in difficulties associated with collecting, storing, managing, transferring, sharing, analyzing, and/or visualizing the data in a timely manner. For example, conventional software tools, relational databases, and/or storage mechanisms may be unable to handle petabytes or exabytes of loosely structured data that is generated on a daily and/or continuous basis from multiple, heterogeneous sources. Instead, management and processing of “big data” may require massively parallel software running on a large number of physical servers. In addition, computational, storage, and/or manual overhead associated with performing analytics may increase as multiple versions of data sets are created, stored, managed, and consumed.

Consequently, big data analytics may be facilitated by mechanisms for efficiently collecting, storing, managing, compressing, transferring, sharing, analyzing, processing, defining, and/or visualizing large data sets.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a flowchart illustrating the process of outputting versions of a set of derived data sets for retrieval through an offline data store in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

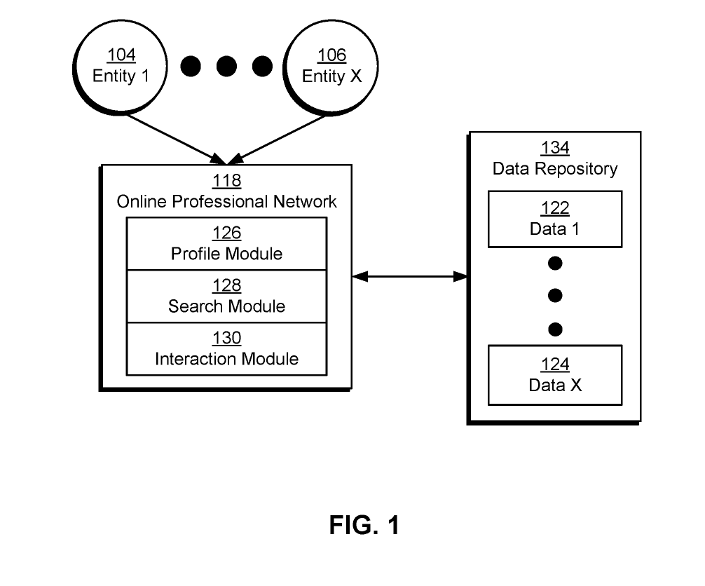

The disclosed embodiments provide a method, apparatus, and system for processing data. As shown in FIG. 1, the data may be used with a social network, such as an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

The entities may use a profile module 126 in online professional network 118 to create and edit profiles containing information related to the entities' professional and/or industry backgrounds, experiences, summaries, projects, skills, and so on. The profile module may also allow the entities to view the profiles of other entities in the online professional network.

Profile module 126 may also include mechanisms for assisting the entities with profile completion. For example, the profile module may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

The entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on the online professional network to search for profiles, jobs, and/or information by categories such as first name, last name, title, company, school, location, interests, relationship, industry, groups, salary, experience level, etc.

The entities may use an interaction module 130 to interact with other entities on online professional network 118. For example, the interaction module may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, the online professional network may include a homepage, landing page, and/or content feed that provides the latest postings, articles, and/or updates from the entities' connections and/or groups to the entities. Similarly, the online professional network may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in the online professional network may be tracked and stored in a database, data warehouse, cloud storage, and/or other data-storage mechanism providing data repository 134.

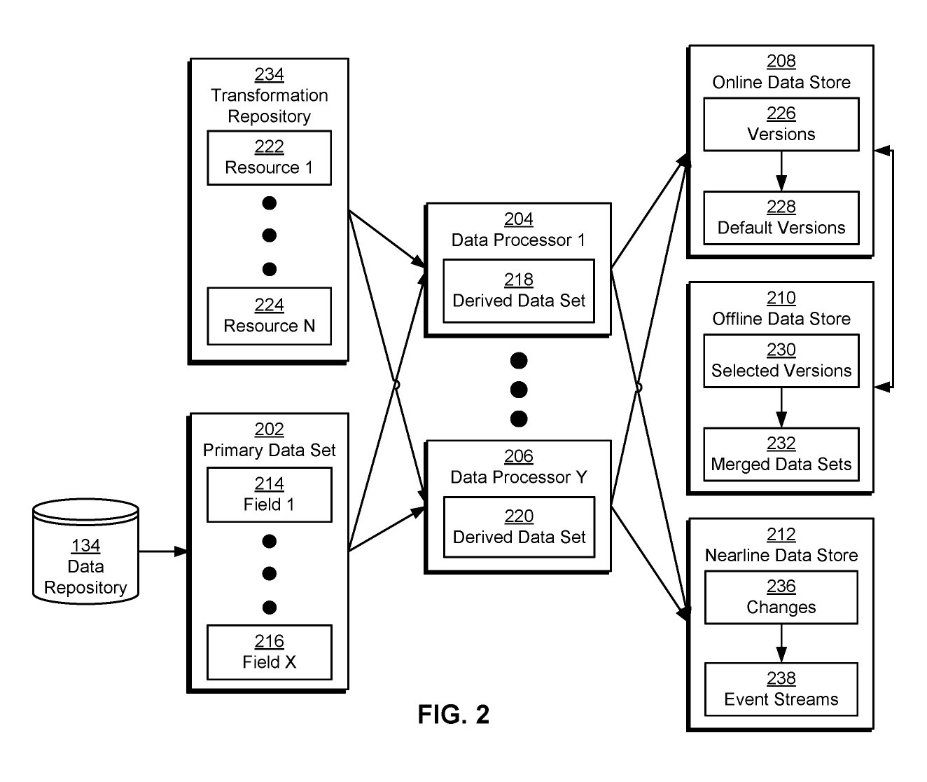

As shown in FIG. 2, data repository 134 and/or another primary data store may be queried for a primary data set 202 that includes a set of fields (e.g., field 1 214, field x 216). For example, the primary data set may include profile data associated with member profiles in a social network, such as online professional network 118 of FIG. 1. Fields in the primary data set may include attributes for each member of the social network, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. The fields may also include a set of groups to which the member belongs, the member's contacts and/or connections, and/or other data related to the member's interaction with the social network.

Attributes of the members may be matched to a number of member segments, with each member segment containing a group of members that share one or more common attributes. For example, member segments in the social network may be defined to include members with the same industry, location, and/or language.

Connection information in the profile data may additionally be combined into a graph, with nodes in the graph representing entities (e.g., users, schools, companies, locations, etc.) in the social network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

In one or more embodiments, the system of FIG. 2 includes functionality to standardize member attributes found in member profiles of members in the social network. The member attributes may include values of locations, skills, titles, industries, companies, schools, summaries, publications, patents, and/or other fields in the member profiles. The member attributes may be extracted from the respective fields 214-216 in primary data set 202, matched to standardized member attributes in one or more taxonomies from a transformation repository 234, and stored and/or replaced with the standardized member attributes in one or more derived data sets 218-220. For example, skills in the member profiles may be organized into a hierarchical taxonomy that is stored in a relational database, distributed filesystem, and/or other data storage mechanism providing the transformation repository. The taxonomy may model relationships between skills (e.g., “Java programming” is related to or a subset of “software engineering”) and/or standardize identical or highly related skills (e.g., “Java programming,” “Java development,” “Android development,” and “Java programming language” may be normalized to “Java”).

Such standardization of member attributes may facilitate analysis of the member attributes by statistical models and/or machine learning techniques, as well as use of the member attributes with products in and/or associated with the social network. For example, transformation of a set of related and/or synonymous skills into the same standardized skill of “Java” may improve the performance of a statistical model that uses the skills to generate recommendations, scores, predictions, classifications, and/or other output that is used to modulate features and/or interactions in the social network. In another example, a search for members with skills that match “Java development” may be matched to a group of members with the same standardized skill of “Java,” which is returned in lieu of a smaller group of members that specifically list “Java development” as a skill. In a third example, standardization of a first company's name into the name of a second company that acquired the first company may allow a link to the first company in a member profile to be redirected to a company page for the second company in the social network.

In general, the system of FIG. 2 includes functionality to perform unified multiversioned processing of derived data, such as standardized member attributes in member profiles of social networks. Other types of derived data processed by the system may include, but are not limited to, topics and/or other natural language processing (NLP) data sets, scores (e.g., relevance scores, reputation scores, connection strength scores, etc.), and/or derived features for inputting into statistical models. As mentioned above, a number of derived data sets 218-220 may be produced from fields in primary data set 202 and one or more resources (e.g., resource 1 222, resource n 224) from transformation repository 234. For example, a number of derived data sets may be created from various member attributes stored in data repository 134. Each derived data set may include values of fields associated with a given attribute type in the primary data set, as well as standardized values of the fields that are produced using a taxonomy in the transformation repository.

More specifically, each derived data set 218-220 may be created by a separate data processor (e.g., data processor 1 204, data processor y 206). Continuing with the previous example, a separate nearline stream processor and/or other type of processing node may be used to generate a set of standardized member attributes from a different type of member attribute (e.g., skill, title, seniority, industry, company, school, location, etc.) stored in data repository 134. Conversely, multiple derived data sets may be produced by the same data processor (e.g., when the derived data sets are relatively small and/or do not require significant computational resources to generate).

As changes 236 are made to the fields of primary data set 202, one or more data processors may update the corresponding derived data set(s). For example, the addition of a skill to a member's profile in the social network (e.g., through profile module 126 of FIG. 1) may trigger the generation of a “skill added” event, which is received by a data processor that subscribes to the “skill added” event stream and produces a derived data set of standardized skills in the social network. In response to the event, the data processor may use a taxonomy from transformation repository 234 to add a standardized representation of the skill to a record for the member in the derived data set.

After derived data sets 218-220 are produced, derived data sets 218-220 may be consumed and/or retrieved by a set of clients through an online data store 208, an offline data store 210, and/or a nearline data store 212. Online data store 208 may be used for real-time querying of derived data sets 218-220, which are created and/or updated on a real-time or near-real-time basis by the corresponding data processors. For example, the clients may query online data store 208 for up-to-date standardized member attributes associated with individual members of the social network (e.g., by specifying identifiers of the members in the queries) and/or attribute types in the members' profiles (e.g., by specifying the attribute types in the queries).

Offline data store 210 may store batch-processing and/or offline-processing results associated with derived data sets 218-220. For example, derived data sets containing different types of standardized member attributes (e.g., skills, titles, seniorities, industries, companies, schools, locations, etc.) from online data store 208 may periodically (e.g., on a daily basis) be merged by an offline process into one or more merged data sets 232. Each merged data set may provide a partial or full set of standardized member attributes for members of the social network. As a result, the merged data set may be a single data source of standardized member attributes consolidated from separate derived data sets.

Nearline data store 212 may transmit recent changes 236 to derived data sets 218-220 in event streams 238 representing the derived data sets. For example, an update to a derived data set by a data processor may trigger the outputting of an event representing the update to an event stream for the derived data set. In turn, a client may subscribe to the event stream to receive the most recent changes 236 to the derived data set, independently of querying online data store 208 for data from specific derived data sets and/or records in the derived data sets.

Those skilled in the art will appreciate that the data processors may generate multiple versions 226 of derived data sets 218-220 from primary data set 202 and resources in transformation repository 234. For example, transformation repository 234 may include multiple versions of a taxonomy for standardizing skills in the member profiles. Newer versions of the taxonomy may be produced to include new skills, remove invalid skills, and/or change the hierarchical relationships between skills and/or normalization of the skills. Because a version of the taxonomy may produce standardized skills that are incompatible with a given statistical model, product, social network feature, and/or other client that consumes standardized skills, each supported (e.g., non-deprecated) version of the taxonomy may be used to produce a corresponding version of a standardized set of skills from primary data set 202. All supported versions of the standardized set of skills may then be outputted for retrieval by the clients through online data store 208, offline data store 210, and nearline data store 212 to enable access to compatible versions of standardized skill sets by the clients. As with creation of individual derived data sets 218-220, the same data processor and/or different data processors may be used to create multiple versions of a derived data set from fields in primary data set 202 and resources in transformation repository 234.

Conversely, a client may be agnostic to the version of the derived data set consumed by the client. For example, a client that returns a list of members in response to a search for skills, titles, seniorities, industries, locations, schools, companies, and/or other member attributes matching the members may generate search results independently of the specific sets of standardized member attributes used to produce the search results. As a result, the client may be capable of consuming any derived data set containing standardized member attributes of members in a social network.

In one or more embodiments, the system of FIG. 2 includes functionality to produce default versions 228 of derived data sets 218-220 from multiple versions of the derived data sets. Each default version may be selected from available (e.g., supported) versions of the corresponding derived data set. For example, the default version may be specified as the most recent stable (e.g., tested) version of the derived data set.

Default versions 228 may also, or instead, be created from two or more versions of the derived data set. For example, a default version of a derived data set may include a mix of data from the most recent stable version of the derived data set and one or more newer versions of the derived data set. An A/B test may be used to select individual records from the most recent stable version and the newer version(s) for inclusion in the default version. Such mixing of data from multiple versions of the derived data set into the default version may allow the performance of the newer version(s) to be compared with that of the most recent stable version. In turn, the assessed performance of the newer version(s) may be used to ramp the newer version(s) up or down in subsequent default versions of the derived data set.

Because default versions 228 of derived data sets 218-220 may contain data that is selected from multiple versions of the derived data set, the default versions may be unsuited for consumption by clients that require specific versions of the derived data sets. Conversely, the default versions may reduce overhead and/or manual configuration associated with consuming the derived data sets by clients that are not reliant on specific versions of the derived data sets.

Multiple versions 226 and default versions 228 of derived data sets 218-220 may additionally be created and/or served in different ways by online data store 208, offline data store 210, and nearline data store 212. First, online data store 208 may store multiple versions 226 of each derived data set 218-220 in separate data sources, such as a separate database table for each version of the derived data set. As a result, a query that specifies a given version of the derived data set may be used to retrieve one or more records from the data source storing the version of the derived data set. Online data store 208 may provide a default version of the derived data set by returning, in response to queries that do not specify the versions of one or more derived data sets, individual records that map to the default versions of the derived data set(s) (e.g., as identified using one or more A/B tests associated with the derived data set(s)).

For example, an exemplary query of online data store 208 may include the following:

d2://memberDerivedData/urn:li:member:1234567 ?fields=standardizedSkills.standardizedEducations,standardizedLocation, standardizedPositions,standardizedProfileIndustries& versions.MemberStandardizedSeniority=V04& versions.MemberStandardizedTitle=V04

The above query may be directed to an online data store named “memberDerivedData.” The query may include an identifier of “1234567” for a member in a social network, followed by a set of fields named “standardizedSkills,” “standardizedEducations,” “standardizedLocation,” “standardizedPositions,” and “standardizedProfileIndustries.” The query additionally includes specified versions of “V04” for derived data sets named “memberStandardizedSeniority” and “memberStandardizedTitle,” which may be used to retrieve values of fields associated with “standardizedPositions” from the “V04” versions of the “MemberStandardizedSeniority” and “MemberStandardizedTitle” data sets. On the other hand, remaining fields in the query may lack a corresponding specified version. As a result, the values of the fields may be obtained from default versions of the corresponding derived data sets, which may be the only versions, the most recent stable versions, and/or newer versions (e.g., as selected by A/B tests) of the derived data sets.

Second, offline data store 210 may create multiple merged data sets 232 from selected versions 230 of derived data sets 218-220. Selected versions 230 may include client-specified versions of derived data sets 218-220. For example, a merged data set may be created using the following exemplary workflow:

| workflow(“member-derived-data-merger-flow”) { | |
|---|---|
| hadoopJavaJob(“member-derived-data-merger-job”) { | |
| uses “standardization.MemberDerivedDataMerger” | |
| jvmClasspath “./*:./lib/*:\${hadoop.home}/lib/” | |
| set properties: [ | |
| “standardized.company.version” | : “3.0.0”, |
| “standardized.industry.version” | : “1.0.0”, |
| “standardized.skill.version” | : “0.1.9”, |
| “standardized.title.version” | : “2.0.0”, |
| ] | |

```
  }
  targets “member-derived-data-merger-job”
}
```

In the above workflow, numeric versions of “3.0.0,” “1.0.0,” “0.1.9” and “2.0.0” are specified for derived data sets named “standardized.company,” “standardized.industry,” “standardized.skill” and “standardized.title,” respectively. In turn, a batch-processing job may be used to retrieve the specified versions of the derived data sets from individual data sources within online data store 208 and/or another source of the derived data sets and merge the versions into a single client-specific merged data set that is accessible via offline data store 210.

A default merged data set may similarly be created from default versions of the corresponding derived data sets. For example, one or more batch-processing jobs may run the same A/B test and/or mixing logic for generating the default version of each derived data set in online data store 208 to select individual records from a most recent stable version and/or one or more newer versions of the derived data set. The selected records may be included in a data source representing the default version of the derived data set within offline data store 210, such as a directory in a distributed filesystem. Default versions of multiple derived data sets may then be combined from the corresponding data sources in offline data store 210 to produce the default merged data set.

Third, nearline data store 212 may output multiple versions of changes 236 to a given derived data set in multiple event streams 238. For example, a change in a member's title in primary data set 202 may be used by one or more data processors to update a record for the member in multiple versions of a derived data set containing standardized versions of titles in a social network. In turn, the data processor(s) may produce events signaling the updated record in event streams with names such as “MemberStandardizedTitleMessageV2” and “MemberStandardizedTitleMessageV4.” The data processor(s) may also execute the same A/B test and/or mixing logic used to generate a default version of the derived data set in online data store 208 and offline data store 210 to select the updated record from only one version of the derived data set as the default version and output the default version in an event stream with a name of “MemberStandardizedTitleMessage.” In turn, clients that subscribe to each event stream may be notified of the update in the corresponding version of the derived data set.

By outputting derived data sets in online data store 208, offline data store 210, and nearline data store 212, the system of FIG. 2 may accommodate different use cases associated with consuming the derived data sets by various clients. At the same time, the creation and management of multiple versions of the derived data sets, including default versions of the derived data sets, may facilitate both improvements to the derived data sets over time and compatibility of the derived data sets with the execution of the clients.

Those skilled in the art will appreciate that the system of FIG. 2 may be implemented in a variety of ways. More specifically, the data processors, online data store 208, offline data store 210, nearline data store 212, data repository 134, and transformation repository 234 may be provided by a single physical machine, multiple computer systems, one or more virtual machines, a grid, one or more databases, one or more filesystems, and/or a cloud computing system. Instances of the data processors, online data store 208, offline data store 210, nearline data store 212, data repository 134, and/or transformation repository 234 may also be scaled to the number of fields in the primary data set, the size of the primary data set, the volume of requests to online data store 208, the volume of data in offline data store 210, and/or the volume of changes 234 in nearline data store 212.

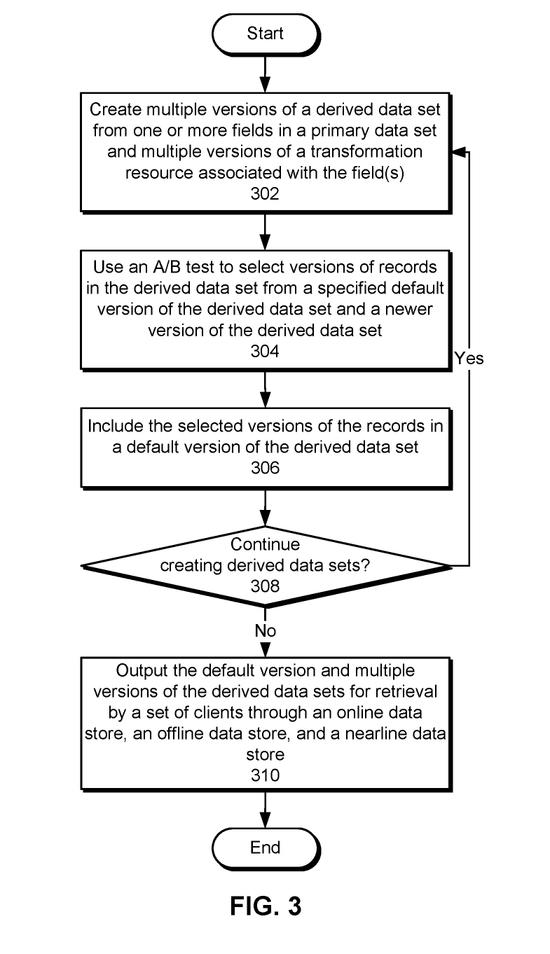

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the technique.

Initially, a set of derived data sets is obtained for use by a set of clients. The derived data sets may include multiple versions of a derived data set, which are created from one or more fields in a primary data set and multiple versions of a transformation resource associated with the field(s) (operation 302). For example, the primary data set may include profile data for member profiles in a social network, and the transformation resource may include a set of standardization taxonomies for the profile data. The derived data set may be generated from one or more fields in the primary data set by using one or more of the standardization taxonomies to map values of the field(s) to standardized member attributes. The standardized member attributes may then be stored with the original values in the derived data set and/or used to replace the original values in the derived data set.

Next, a default version of the derived data set is produced from the multiple versions of the derived data set. In particular, an A/B test may be used to select versions of records in the derived data set from a specified default version (e.g., a most recent stable version) of the derived data set and a newer version of the derived data set (operation 304). For example, the A/B test may be used to ramp up the newer version based on the relative performance of the newer version, compared with the performance of the specified default version. The selected versions of the records are then included in the default version (operation 306). Continuing with the previous example, the default version may include a percentage of records from the newer version (e.g., 5%), as specified in parameters for the A/B test, and a remaining percentage of records from the specified default version (e.g., 95%). Alternatively, the default version may include only records from the specified default version if mixing of data from multiple versions of the derived data set into the default version is to be omitted.

Operations 302-306 may be repeated during creation of derived data sets (operation 308). For example, multiple versions and a default version of a derived data set may be produced for each member attribute in a social network with a corresponding standardization taxonomy and/or other transformation resource. In turn, derived data sets associated with profile data in the social network may include sets of standardized and/or otherwise transformed skills, titles, seniorities, industries, companies, schools, and/or locations of members in the social network.

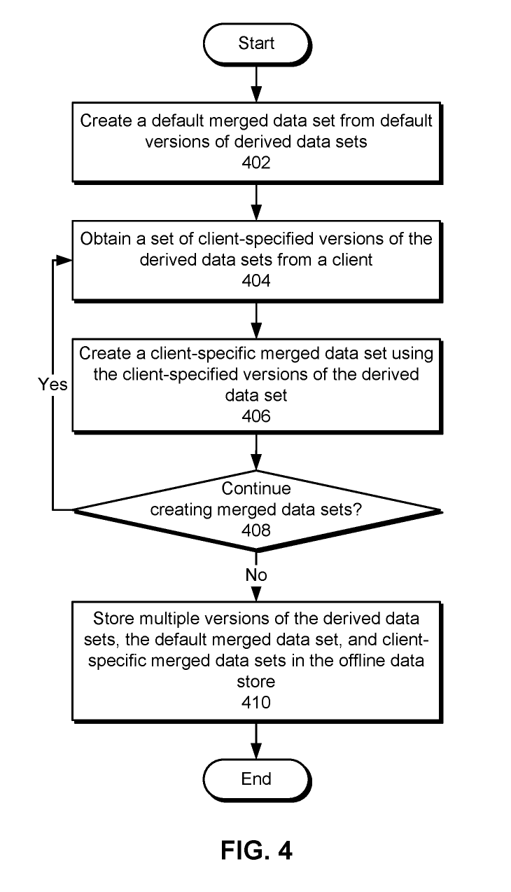

Finally, the default version and multiple versions of the derived data sets are outputted for retrieval by a set of clients through an online data store, an offline data store, and a nearline data store (operation 310). For example, a version of a derived data set may be obtained from a query of the online data store, and one or more records from a data source (e.g., database table) storing the version of the derived data set in the online data store may be returned in a response to the query. If no version is specified for the data set, the default version of the derived data set may be calculated by the online data store and returned. In another example, various versions of the derived data sets may be merged into merged data sets in the offline data store, as described in further detail below with respect to FIG. 4. In a third example, multiple versions of a change in a derived data set are outputted in multiple event streams of the nearline data store. A version of the change is then selected from the multiple versions for outputting in an event stream representing the default version of the derived data set.

FIG. 4 shows a flowchart illustrating the process of outputting versions of a set of derived data sets for retrieval through an offline data store in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the technique.

First, a default merged data set is created from default versions of the derived data sets (operation 402). For example, a default version of each derived data set may be created using a specified default version and/or a newer version of the derived data set, as described above. The default versions of the derived data sets may then be merged into the default merged data set.

Next, a set of client-specified versions of the derived data sets is obtained (operation 404). For example, the client-specified versions may be obtained as parameters from a workflow, configuration, and/or other source of the parameters from a client. A client-specific merged data set is then created using the client-specified versions (operation 406). For example, client-specified numeric versions of derived data sets containing standardized member attributes for members of a social network may be merged into a client-specific merged data set that contains a customized set of the standardized member attributes for consumption by the client. Operations 404-406 may be repeated during creation of merged data sets (operation 408) from client-specified versions of derived data sets. For example, a different client-specific merged data set may be created for each set of client-specified versions obtained from clients that consume the derived data sets.

Finally, multiple versions of the derived data sets, the default merged data set, and the client-specific merged data sets are stored in the offline data store (operation 410) for subsequent retrieval by the clients. For example, each version of a derived data set may be stored within a separate directory in a distributed filesystem and/or other data source in the offline data store. Similarly, the merged data sets may be stored in separate directories and/or other data sources in the offline data system that identify the corresponding versions (e.g., default, client-specific, etc.) of the merged data sets. A client may then retrieve a given merged data set from the offline data system using a path to the directory and/or data source storing the merged data set.

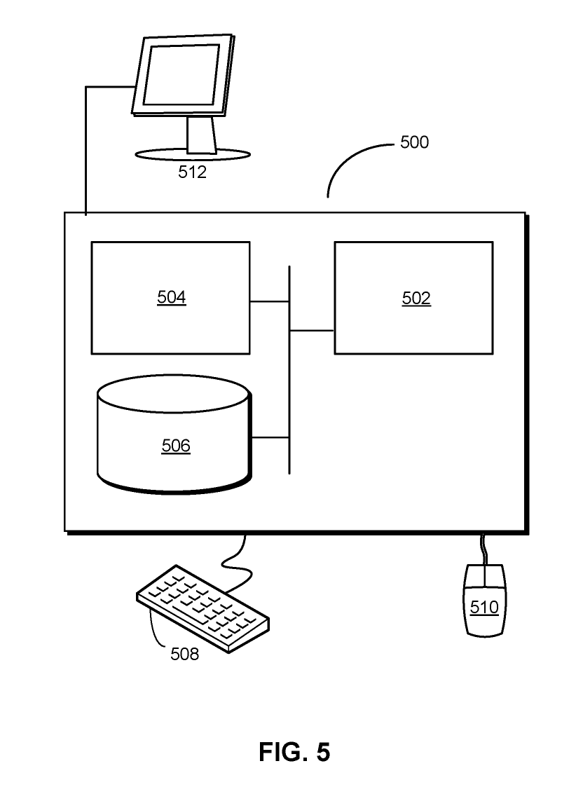

FIG. 5 shows a computer system 500. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system includes an online data store, an offline data store, a nearline data store, and a set of data processors. The data processors may obtain a set of derived data sets for use by a set of clients. For each derived data set in the set of derived data sets, the data processors may produce a default version of the derived data set from multiple versions of the derived data set. The data processors may then output the default version and the multiple versions for retrieval by the set of clients through the online data store, offline data store, and nearline data store.

In addition, one or more components of computer system 500 may be remotely located and connected to the other components over a network. Portions of the present embodiments (e.g., online data store, offline data store, nearline data store, data processors, data repository, transformation repository, etc.) may also be located on different nodes of a distributed system that implements the embodiments. For example, the present embodiments may be implemented using a cloud computing system that generates and manages multiple versions of derived data sets for a set of remote clients.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of derived data sets for use by a set of clients;
for each derived data set in the set of derived data sets:
producing, by one or more computer systems, a default version of the derived data set from multiple versions of the derived data set; and
outputting the default version and the multiple versions for retrieval by the set of clients through an online data store, an offline data store, and a nearline data store.

2. The method of claim 1, wherein producing the default version of the derived data set from the multiple versions of the derived data set comprises:
for each record in the derived data set, using an AB test to select a version of the record from a specified default version of the derived data set and a newer version of the derived data set; and
including the selected version of the record in the default version of the derived data set.

3. The method of claim 1, wherein outputting the default version and the multiple versions for retrieval by the set of clients through the offline data store comprises:
obtaining a set of client-specified versions of the derived data sets from a client;
creating a client-specific merged data set using the client-specified versions of the derived data sets; and
storing the client-specific merged data set in the offline data store for subsequent retrieval by the client.

4. The method of claim 3, wherein outputting the default version and the multiple versions for retrieval by the set of clients through the offline data store further comprises:
creating a default merged data set from default versions of the derived data sets; and
storing the default merged data set in the offline data store for subsequent retrieval by the client.

5. The method of claim 3, wherein outputting the default version and the multiple versions for retrieval by the set of clients through the offline data store further comprises:
storing the multiple versions of the derived data set in the offline data store for subsequent retrieval by the client.

6. The method of claim 3, wherein the merged data set comprises a set of standardized member profiles in a social network.

7. The method of claim 6, wherein the derived data sets comprise at least one of:
a set of skills;
a set of titles;
a set of seniorities;
a set of industries;
a set of companies;
a set of schools; and
a set of locations.

8. The method of claim 1, wherein outputting the default version and the multiple versions for retrieval by the set of clients through the online data store comprises:
obtaining a version of a derived data set from a query of the online data store; and
returning, in a response to the query, one or more records from a data source storing the version of the derived data set in the online data store.

9. The method of claim 1, wherein outputting the default version and the multiple versions for retrieval by the set of clients through the nearline data store comprises:
outputting the multiple versions of a change in a derived data set in multiple event streams of the nearline data store.

10. The method of claim 9, wherein outputting the default version and the multiple versions for retrieval by the set of clients through the nearline data store further comprises:
selecting, from the multiple versions of the change, a version of the change for outputting in an event stream representing the default version of the derived data set.

11. The method of claim 1, wherein obtaining the set of derived data sets for use by the set of clients comprises:
for each derived data set in the set of derived data sets, creating the multiple versions of the derived data set from one or more fields in a primary data set and the multiple versions of a transformation resource associated with the one or more fields.

12. The method of claim 11, wherein the transformation resource comprises at least one of:
a standardization taxonomy;
a set of topics;
a set of scores; and
a set of features.

13. An apparatus, comprising:
one or more processors; and
memory storing instructions that, when executed by the one or more processors, cause the apparatus to:
obtain a set of derived data sets for use by a set of clients; and
for each derived data set in the set of derived data sets:
produce a default version of the derived data set from multiple versions of the derived data set; and
output the default version and the multiple versions for retrieval by the set of clients through an online data store, an offline data store, and a nearline data store.

14. The apparatus of claim 13, wherein producing the default version of the derived data set from the multiple versions of the derived data set comprises:
for each record in the derived data set, using an A/B test to select a version of the record from a specified default version of the derived data set and a newer version of the derived data set; and
including the selected version of the record in the default version of the derived data set.

15. The apparatus of claim 13, wherein outputting the default version and the multiple versions for retrieval by the set of clients through the offline data store comprises:
obtaining a set of client-specified versions of the derived data sets from a client;
creating a client-specific merged data set using the client-specified versions of the derived data sets; and
storing the client-specific merged data set in the offline data store for subsequent retrieval by the client.

16. The apparatus of claim 15, wherein outputting the default version and the multiple versions for retrieval by the set of clients through the offline data store further comprises:
creating a default merged data set from default versions of the derived data sets; and
storing the default merged data set in the offline data store for subsequent retrieval by the client.

17. The apparatus of claim 13, wherein outputting the default version and the multiple versions for retrieval by the set of clients through the nearline data store comprises:
outputting the multiple versions of a change in a derived data set in multiple event streams of the nearline data store; and
selecting, from the multiple versions of the change, a version of the change for outputting in an event stream representing the default version of the derived data set.

18. The apparatus of claim 13, wherein outputting the default version and the multiple versions for retrieval by the set of clients through the online data store comprises:
obtaining a version of a derived data set from a query of the online data store; and
returning, in a response to the query, one or more records from a data source storing the version of the derived data set in the online data store.

19. A system, comprising:
an online data store;
an offline data store;
a nearline data store; and
a set of data processors comprising a non-transitory computer-readable medium comprising instructions that, when executed, cause the system to:
obtain a set of derived data sets for use by a set of clients; and
for each derived data set in the set of derived data sets:
produce a default version of the derived data set from multiple versions of the derived data set; and
output the default version and the multiple versions for retrieval by the set of clients through the online data store, the offline data store, and the nearline data store.

20. The system of claim 19, wherein producing the default version of the derived data set from the multiple versions of the derived data set comprises:
for each record in the derived data set, using an A/B test to select a version of the record from a specified default version of the derived data set and a newer version of the derived data set; and
including the selected version of the record in the default version of the derived data set.
